(19) United States
(12) Patent Application Publication
(10) Pub. No.: US 2007/0257243 A1
(43) Pub. Date: Nov. 8, 2007

(54) Variable leverage cranking apparatus

(76) Inventor: Archie Cofer, Nicoma Park, OK (US)

Correspondence Address: DUNLAP CODDING & ROGERS, P.C., PO BOX 16370, OKLAHOMA CITY, OK, 73113, US

(21) Appl. No.: 11/430,149

(22) Filed: May 8, 2006

(51) Int. Cl. B60S 9/02

(52) U.S. Cl. 254/419; 280/420

(57) ABSTRACT

A variable leverage cranking assembly for trailer jacks. The assembly having a housing, an extender assembly, and an attachment assembly. The extender assembly telescopically disposed within the housing such that a distance between a first rotatable handle disposed on the housing and a second rotatable handle disposed on the extender assembly can be telescopically varied so as to change the leverage transmitted to a trailer jack via the attachment assembly connected to the housing. Furthermore, the telescopic adjustment between the housing and extender assembly can be locked into position via a spring loaded latching assembly disposed on the housing and holes disposed in the extender assembly.

### BACKGROUND OF THE INVENTION

Traditionally, a user who wanted to raise or lower a trailer having a trailer jack assembly in engaging contact with the cranking assembly, must manually manipulate a single handle on a lever of non-variable length. The non-variable length and single handle presents problems in situations wherein a trailer may be fully loaded with heavy material. In such situation it would be desirable to have a cranking assembly that could provide variable leverage and/or the ability to grasp such cranking assembly with two hands. It is to such problems that embodiments of the present invention address.

### SUMMARY OF THE INVENTION

The present invention is a variable leverage cranking assembly having a housing, an extender assembly, and an attachment assembly. In one embodiment, the extender assembly is telescopically disposed within the housing such that a distance between a first rotatable handle disposed on the housing and a second rotatable handle disposed on the extender assembly can be telescopically varied so as to change the leverage transmitted to a trailer jack via the attachment assembly connected to the housing.

Furthermore, the telescopic adjustment between the housing and extender assembly can be locked into position via a spring loaded latching assembly disposed on the housing and holes disposed in the extender assembly.

### BRIEF DESCRIPTION OF THE SEVERAL VIEWS OF THE DRAWINGS

FIG. 1 is a perspective view of a first embodiment of the present invention connected to an apparatus to be cranked.

FIG. 2 is a side plan view of the embodiment of FIG. 1 in its non-extended configuration attached to an apparatus to be cranked.

FIG. 3 is a side plan view of the embodiment of FIG. 1 in its extended configuration attached to an apparatus to be cranked.

FIG. 4 is a perspective view of a second embodiment of the present invention in its stored configuration attached to an apparatus to be cranked.

FIG. 5 is a perspective view of the embodiment of FIG. 4 showing the handle able to swing outwards.

FIG. 6 is a side view of the embodiment of FIG. 4 in its extended configuration.

FIG. 7 is a side view of the embodiment of FIG. 4 in its intermediately extended configuration.

FIG. 8 is a side view of the embodiment of FIG. 4 in its non-extended configuration.

FIG. 9 is a side view of a third embodiment of the present invention.

FIG. 10 is a side view of a fourth embodiment of the present invention showing the manual configuration.

FIG. 11 is a side view of the embodiment of FIG. 10 showing the powered configuration.

### DETAILED DESCRIPTION OF THE INVENTION

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for purpose of description and should not be regarded as limiting.

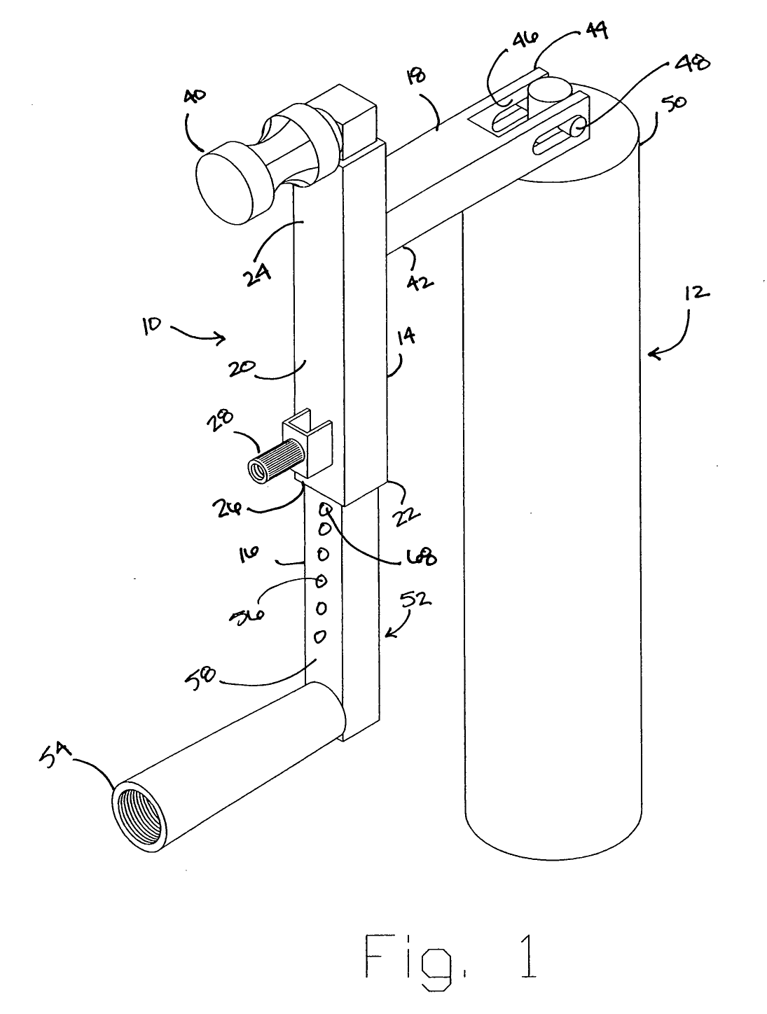

Referring now to the drawings, and more particularly to FIGS. 1-3, shown therein is a variable leverage cranking assembly, generally designated by reference numeral 10, for attaching to a trailer jack 12 and for turning the trailer jack 12 so as to raise or lower the trailer jack or other portion of a trailer.

The variable leverage cranking assembly 10 includes a housing 14, an extender assembly 16 telescopically disposed in the housing 14 and an attachment assembly 18. The housing 14 includes a hollow shank 20, having a first end 22, a second end 24 and a receiving space 26 that extends generally from the first end 22 to the second end 24 of the hollow shank 20. The housing 14 also includes a spring loaded latching assembly 28, connected to or adjacent to the second end 24 of the housing 14. The spring loaded latching assembly 28 includes a pin 30 which extends down into the receiving space 26 of the spring loaded latching assembly 28 and into one hole of a plurality of holes disposed in the extender assembly 16 when the spring loaded latching assembly is in a locked configuration 32. When the spring loaded latching assembly 28, is in an open configuration 34 the pin 30 is retracted and does not extend into the receiving space 26 there by allowing the extender 16 to telescopically move into or out of the housing 14.

The spring loaded latching assembly 28 is typically moved from the closed configuration 32 to the open configuration 34 by pulling the pin 30 in an upward direction 36. The spring loaded latching assembly 28 is moved from the open configuration 34 to the closed configuration 32 by moving the pin 30 in a downward direction 38 such that at least a portion of the pin 30 extends into the receiving space 26 of the housing 14. Also connected to the housing 14 near the second end 24 of the housing 14 is a first rotatable handle 40 sized and configured so as to be easily grasped and manually manipulated.

Connected to the housing 14 near the second end 24 of the housing 14 is the attachment assembly 18. The attachment assembly 18 extends generally from the housing 14 in a perpendicular direction from the first hollow shank 20. The attachment assembly 18 includes a first end 42 connected to the second end 24 of the housing 14. The attachment assembly 18 also includes a second end 44. The second end 44 includes a clearance space 46 generally sized and configured so as to receive a pin 48 connected to the trailer jack.

The extender assembly 16 includes a body 52 and a second rotatable handle 54. The second rotatable handle 54 is generally sized and configured so as to be conveniently grasped and manually manipulated by an operator. The second rotatable handle 54 generally extends in a generally perpendicular direction from the body 52. The body 52 is sized and configured such that the body 52 telescopically slides into and out of the receiving space 26 of the housing 14. The body 52 also includes a plurality of holes 56 which typically extend through a top surface 58 and the body 52. The plurality of holes 56 are spaced typically a uniform distance 60 apart. The plurality of holes 56 have a diameter such that the pin 48 of the spring loaded latching assembly 28 can extend down into one of the plurality of holes 56.

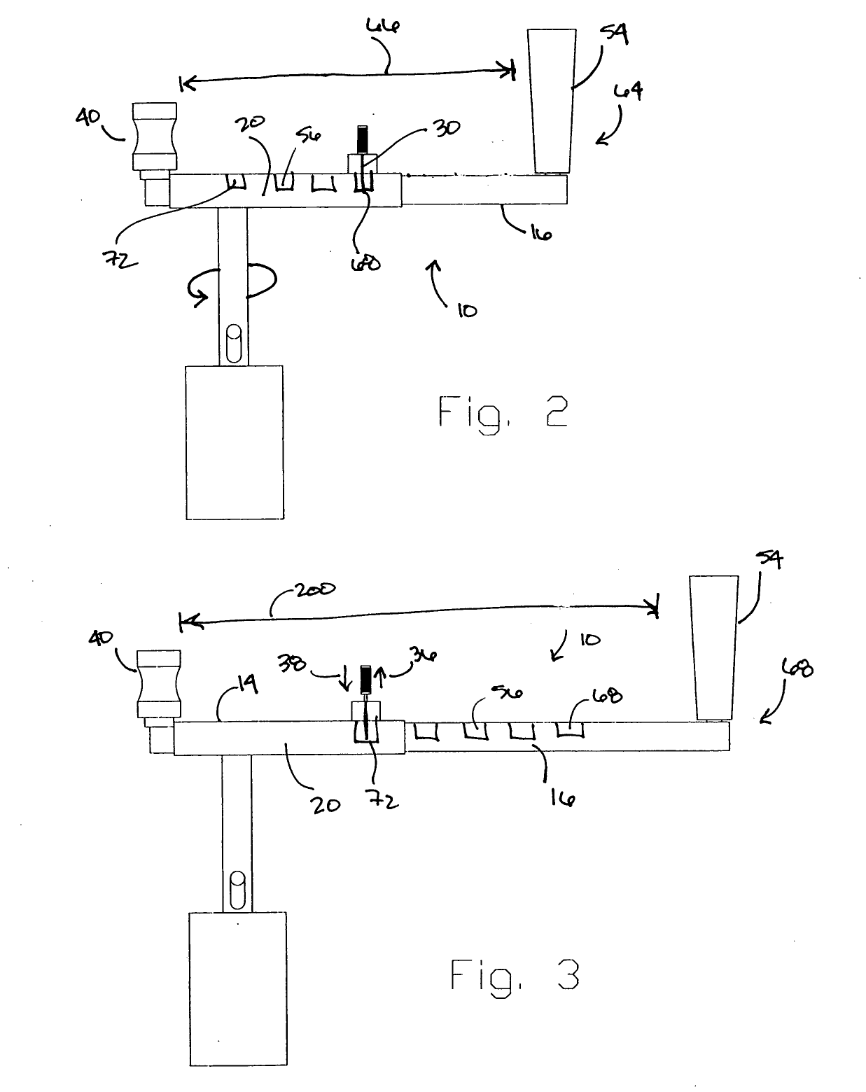

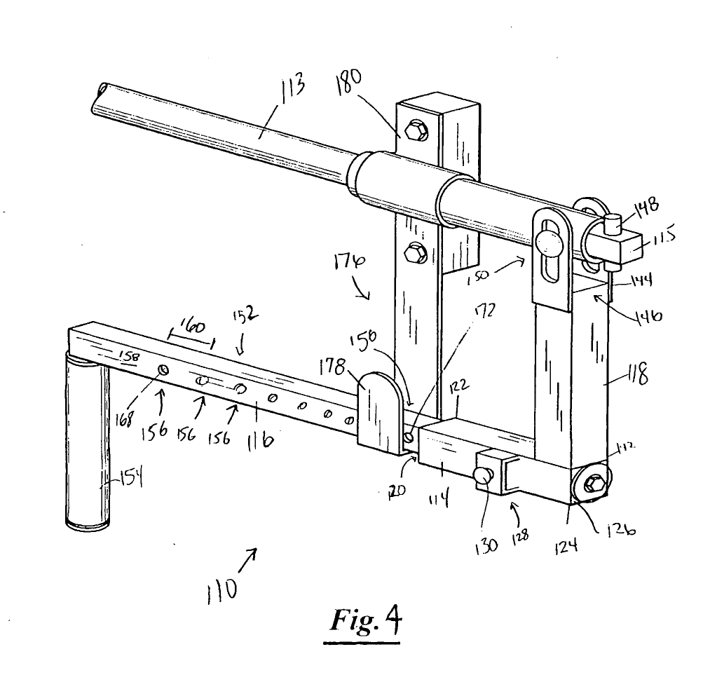

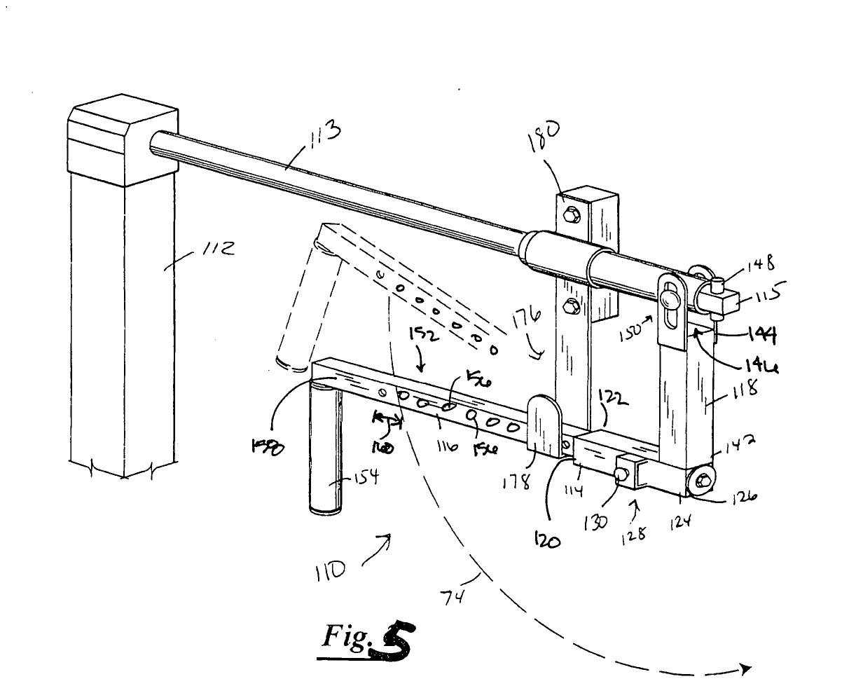

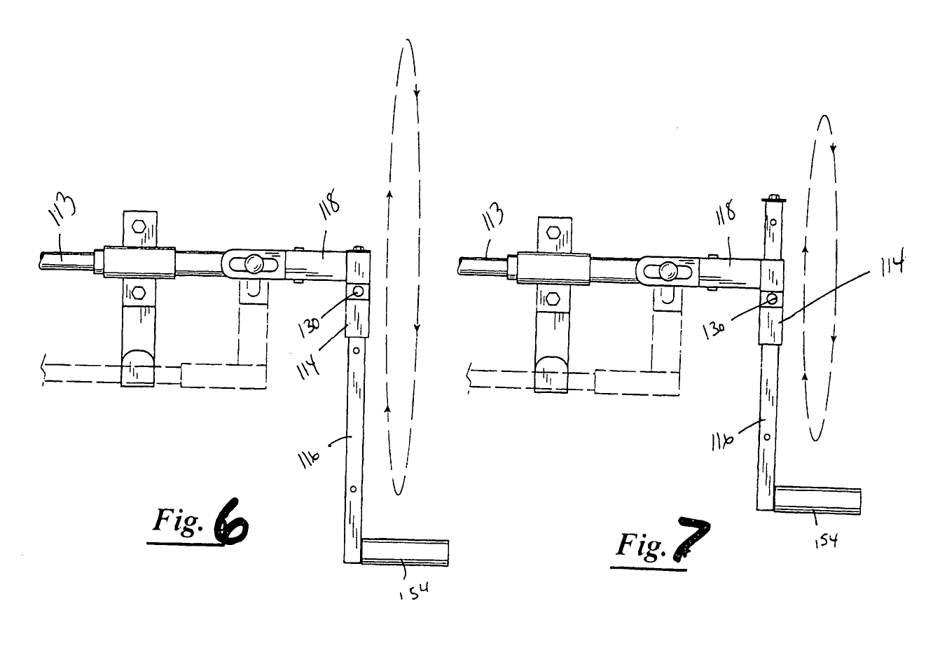

Referring now to FIG. 2, shown therein is the variable leverage cranking assembly 10 is a minimum leverage configuration. In the minimum leverage configuration the extender assembly 16 is disposed in the housing 14 such that there is a minimum distance 66 between the first rotatable handle 40 and the second rotatable handle 54. In this minimum leverage configuration the pin 30 is disposed in the first hole 68 in the extender assembly.

Referring now to FIG. 3, shown therein is the variable leverage cranking assembly 10 in its maximum leverage configuration. In the maximum leverage configuration the housing 14 and the extender assembly 16 is disposed such that there is a maximum distance between the first rotatable handle 40 and the second rotatable handle 54 and the pin 48 is disposed such that in the closed configuration the pin extends into a last hole 72 in the extender assembly 16. It should be noted that there can be any number of holes between the first hole 68 and the last hole 72.

By varying the distance between the first rotatable handle 40 and the second rotatable handle 54 leverage transmitted to the trailer jack though the attachment assembly 18 can be varied thereby making it easier or harder to crank the trailer jack assembly 12. It should also be noted that by providing a first rotatable handle 40 and a second rotatable handle 54 an operator can utilize both hands to manipulate the variable leverage cranking assembly 10 thereby making it easier and more convenient to raise or lower a trailer jack 12.

It should also be noted in FIGS. 2 and 3 that the variable coverage cranking assembly 16 shown in the operational position such that the variable leverage cranking assembly 10 swings in an upward direction 74 in order to engage the pin 30 on the trailer jack 12.

Referring now FIGS. 4-7, shown therein is a second embodiment of a variable leverage cranking assembly, generally designated by reference numeral 110, for attaching to a trailer jack 112 (shown in FIG. 5) and for cranking the trailer jack 112 so as to raise or lower a trailer. The variable leverage cranking assembly 110 includes a housing 114, an extender assembly 116 telescopically disposed in the housing 114 and an attachment assembly 118. The housing 114 includes a hollow shank 120, having a first end 122, a second end 124 and a receiving space 126 that extends generally from the first end 122 to the second end 124 of the hollow shank 120. The housing 114 also includes a spring loaded latching assembly 128 adjacent the second end 124 of the housing 114. The spring loaded latching assembly 128 includes a pin 130 which extends down into the receiving space 126 of the spring loaded latching assembly 128 and into one hole of a plurality of holes 156 disposed in the extender assembly 116 when the spring loaded latching assembly is in a locked configuration. When the spring loaded latching assembly 128 is in an open configuration, the pin 130 is retracted and does not extend into the receiving space 126 there by allowing the extender 116 to telescopically move into or out of the housing 114.

The spring loaded latching assembly 128 is typically moved from the closed configuration to the open configuration by pulling the pin 130 in an outward direction. The spring loaded latching assembly 128 is moved from the open configuration to the closed configuration by moving the pin 130 in an inward direction such that at least a portion of the pin 130 extends into the receiving space 126 of the housing 114.

Connected to the housing 114 near the second end 124 of the housing 114 is the attachment assembly 118. The attachment assembly 118 extends generally from the housing 114 in a perpendicular direction from the first hollow shank 120. The attachment assembly 118 includes a first end 142 connected to the second end 124 of the housing 114. The attachment assembly 118 also includes a second end 144. The second end 144 includes a clearance space 146 generally sized and configured so as to receive a pin 148 connected to the drive rod 113 of the trailer jack's jack apparatus 112.

The extender assembly 116 includes a body 152 and a rotatable handle 154. The rotatable handle 154 is generally sized and configured so as to be conveniently grasped and manually manipulated by an operator. The rotatable handle 154 generally extends in a generally perpendicular direction from the body 152. The body 152 is sized and configured such that the body 152 can telescopically slide into and out of the receiving space 126 of the housing 114. The body 152 also includes a plurality of holes 156 therein or there-through which typically extend through a top surface 158 and the body 152. The plurality of holes 156 are preferably spaced a uniform distance 160 apart. The plurality of holes 156 have a diameter such that the pin of the spring loaded latching assembly 128 can extend down into one of the plurality of holes 156.

The variable leverage cranking assembly 110 preferably including a storage assembly 176 configured for holding the extender assembly 116 when the extender assembly 116 is not being used to assist in the rotation of the drive rod 113. In the embodiment shown in FIGS. 4-7, the storage assembly 176 comprising a storage flange 178 adapted for receiving at least a portion of the extender assembly 116 therein. In the embodiment shown, the storage assembly 176 further comprising an attachment assembly flange 180 configured for attachment to a surface, for instance the frame of the trailer.

FIG. 4 showing the extender assembly 116 stored within the storage flange 178, whereas FIG. 5 shows how the extender assembly 116 and attached attachment assembly 118 can be rotated the pivot connection 150 present at connection between the second end 144 and the attachment assembly 118, lifted out of the storage flange 178 and rotated into position for engaging the drive rod end 115, as shown in FIGS. 6-8.

As FIGS. 6-8 show, the second end 144 of the attachment assembly 118 is adapted for connecting with the drive rod 113 of the trailer jack jack apparatus 112. When pivoted into place and slid into engagement with the end 115 of the drive rod 113 and/or the drive rod pin 148, rotation of the variable leverage cranking assembly 110 resulting in rotation of the drive rod 113 of the trailer jack jack apparatus 112 thereby raising or lowering the trailer jack.

Referring now to FIG. 6, shown therein is the variable leverage cranking assembly 110 in its maximum leverage configuration. In the maximum leverage configuration the housing 114 and the extender assembly 116 is disposed such that there is a maximum distance between the second end 124 of the hollow shank 120 and the rotatable handle 154. In such a configuration, the pin 130 is disposed such that in the closed configuration the pin 130 extends into a last hole 172 in the extender assembly 116. It should be noted that there could be any number of holes between the first hole 168 and the last hole 172.

Referring now to FIG. 7, shown therein is the variable leverage cranking assembly 110 in an intermediate leverage configuration. In the intermediate leverage configuration, the extender assembly 116 is disposed in the housing 114 such that there is an intermediate distance between the second end 124 of the hollow shank 120 and the rotatable handle 154. In such a configuration, the pin 130 is disposed such that in the dosed configuration the pin 130 extends into one of the centermost holes 156 in the extender assembly 116.

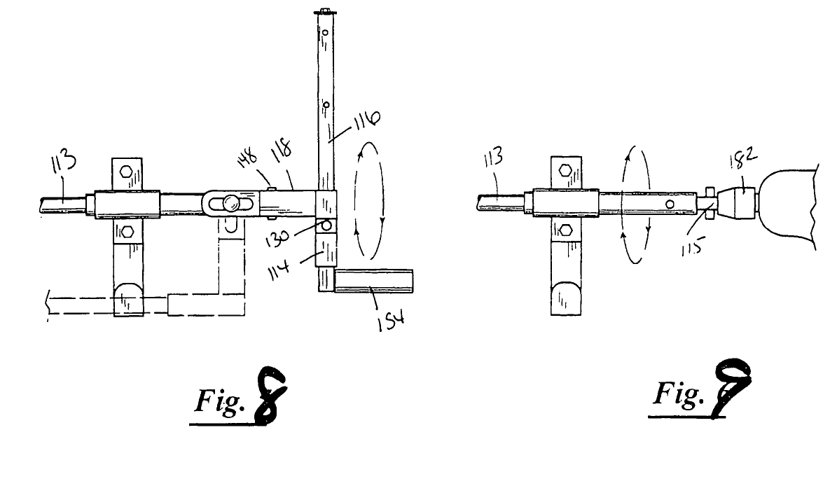

Referring now to FIG. 8, shown therein is the variable leverage cranking assembly 110 in a minimum leverage configuration. In the minimum leverage configuration the extender assembly 116 is disposed in the housing 114 such that there is a minimum distance between the second end 124 of the hollow shank 120 and the rotatable handle 154. In this minimum leverage configuration the pin 130 is disposed in the first hole 168 in the extender assembly.

By varying the distance between second end 124 of the hollow shank 120 and the second rotatable handle 154 leverage transmitted to the trailer jack though the attachment assembly 118 can be varied thereby making it easier or harder to crank the trailer jack assembly 112.

FIG. 9 shows that the chuck 182 of a standard drill, or other power tool, could connect with the drive rod end 115 of the drive rod 113 and thereby drive the rotation of the drive rod 113 causing the trailer jack jack apparatus 112 to raise or lower depending upon the direction the drive rod is driven. Further, other types of manners for driving the drive rod end 115 could be used, both manual and powered.

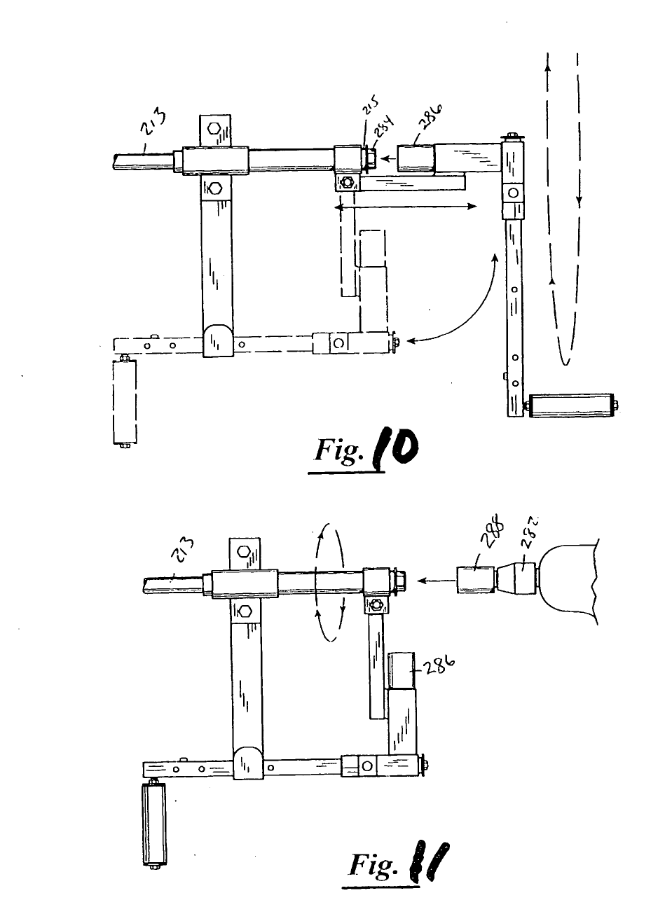

FIGS. 10 and 11 show a third embodiment of the present invention. This embodiment showing that the drive rod end 215 has a nut-style head 284 configured for being driven (and thereby driving the rotation of the drive rod 213) by either a socket 286 attaching to the second end 244 of the attachment assembly 118 (FIG. 10) or a nut driver head 288 held within the chuck 282 of a standard drill. Likewise, socket wrenches, wrenches, and other manual or powered manners of driving the nut-style head 284 could likewise work.

The variable leverage cranking assembly of the present invention is typically constructed of a strong metallic or steel or steel alloy. However, all or any part of the variable leverage cranking assembly could be constructed of any material with sufficient strength to withstand the forces necessary to raise and lower a trailer. Therefore, the size and the material from which the variable leverage cranking assembly is constructed depending on the size and weight of the trailer manipulated by the variable leverage cranking assembly.

In operation the variable leverage cranking assembly is rotated in a circular type motion around the attachment assembly such that the attachment assembly moves the pin in a circular motion thereby cranking the trailer jack up or down depending on the direction of rotation of the variable leverage cranking assembly.

From the above description it is clear the present invention is well adapted to carry out the objectives and obtain the advantages mentioned herein as well as those inherent in the invention while presently preferred its embodiments of the invention have been described for purposes of the disclosure. It will be understood that numerous changes may be made which readily suggests themselves to those skilled in the art.

What I claim is:

1. A variable leverage cranking assembly, comprising:
a housing having an interior area;
an extender assembly, wherein the extender assembly telescopically resides within the interior area of the housing; and
an attachment assembly capable of attaching the housing to an item of interest.

2. The variable leverage cranking assembly of claim 1, wherein the housing further comprises:
a hollow shank having a hollow shank first end, a hollow shank second end and a receiving space that extends from the first end to the second end; said receiving space configured for receiving there-through said extender assembly.

3. The variable leverage cranking assembly of claim 2, wherein said hollow shank second end is configured for attaching to said attachment assembly.

4. The variable leverage cranking assembly of claim 2, wherein said housing further comprises:
a spring loaded latching assembly connected adjacent said shank second end, said spring loaded latching assembly comprising a pin.

5. The variable leverage cranking assembly of claim 4, wherein said spring loaded latching assembly is configured for use in a locked configuration wherein said pin is configured for extending through a hole defined in an extender assembly and into receiving space.

6. The variable leverage cranking assembly of claim 4, wherein said spring loaded latching assembly is configured for use in an open configuration wherein said pin is retracted and does not extend into the receiving space thereby allowing the extender assembly to telescope more into or out of the housing.

7. The variable leverage cranking assembly of claim 1, wherein said housing further comprising a first rotatable handle.

8. The variable leverage cranking assembly of claim 4, wherein said extender assembly comprises a body configured for insertion into said interior area, said body having extending there-from a second rotatable handle extending generally perpendicular direction from the body.

9. The variable leverage cranking assembly of claim 2, wherein said extender assembly comprises a body configured for telescopically sliding into and out of said receiving space.

10. The variable leverage cranking assembly of claim 8, wherein said body further comprises a plurality of holes defined there-through a top surface thereof, wherein plurality of holes are spaced a uniform distance apart and have a diameter such that the pin of the spring loaded latching assembly can extend down into one of the plurality of holes.

11. The variable leverage cranking assembly of claim 1, wherein said attachment assembly extending generally from the housing in a perpendicular direction from the hollow shank.

12. The variable leverage cranking assembly of claim 11, wherein the attachment assembly includes an attachment first end connected to the shank second end, and an attachment second end including a clearance space generally sized and configured so as to receive a pin connected to trailer jack jack drive rod.

13. A variable leverage cranking assembly, comprising:
a housing having an interior area, wherein said housing comprises a hollow shank having a hollow shank first end, a hollow shank second end and a receiving space that extends from the first end to the second end; said receiving space configured for receiving there-through said extender assembly;
an extender assembly, wherein the extender assembly telescopically resides within the interior area of the housing, said extender assembly comprising a body configured for insertion into said interior area, said body having extending there-from a second rotatable handle extending generally perpendicular direction from the body; and
an attachment assembly capable of attaching the housing to an item of interest.

14. The variable leverage cranking assembly of claim 13, wherein said hollow shank second end is configured for attaching to said attachment assembly.

15. The variable leverage cranking assembly of claim 13, wherein said housing further comprises a spring loaded latching assembly connected adjacent said shank second end, said spring loaded latching assembly comprising a pin, wherein said spring loaded latching assembly is configured for use in a locked configuration wherein said pin is configured for extending through a hole defined in an extender assembly and into receiving space, wherein said spring loaded latching assembly is configured for use in an open configuration wherein said pin is retracted and does not extend into the receiving space thereby allowing the extender assembly to telescoping more into or out of the housing.

16. The variable leverage cranking assembly of claim 13, wherein said body further comprises a plurality of holes defined there-through a top surface thereof, wherein plurality of holes are spaced a uniform distance apart and have a diameter such that the pin of the spring loaded latching assembly can extend down into one of the plurality of holes.

17. The variable leverage cranking assembly of claim 13, wherein said attachment assembly extending generally from the housing in a perpendicular direction from the hollow shank.

18. The variable leverage cranking assembly of claim 17, wherein the attachment assembly includes an attachment first end connected to the shank second end, and an attachment second end including a clearance space generally sized and configured so as to receive a pin connected to trailer jack jack drive rod.

19. A variable leverage cranking assembly, comprising:
a housing having an interior area, wherein said housing comprises a hollow shank having a hollow shank first end, a hollow shank second end and a receiving space that extends from the first end to the second end; said receiving space configured for receiving there-through said extender assembly, said housing further comprises a spring loaded latching assembly connected adjacent said shank second end, said spring loaded latching assembly comprising a pin, wherein said spring loaded latching assembly is configured for use in a locked configuration wherein said pin is configured for extending through a hole defined in an extender assembly and into receiving space, wherein said spring loaded latching assembly is configured for use in an open configuration wherein aid pin is retracted and does not extend into the receiving space thereby allowing the extender assembly to telescoping more into or out of the housing;
an extender assembly, wherein the extender assembly telescopically resides within the interior area of the housing, said extender assembly comprising a body configured for insertion into said interior area, said body having extending there-from a second rotatable handle extending generally perpendicular direction from the body, wherein said body further comprises a plurality of holes defined there-through a top surface thereof, wherein plurality of holes are spaced a uniform distance apart and have a diameter such that the pin of the spring loaded latching assembly can extend down into one of the plurality of holes; and
an attachment assembly capable of attaching the housing to an item of interest.

20. The variable leverage cranking assembly of claim 19, wherein said attachment assembly extending generally from the housing in a perpendicular direction from the hollow shank and wherein the attachment assembly includes an attachment first end connected to the shank second end, and an attachment second end including a clearance space generally sized and configured so as to receive a pin connected to trailer jack jack drive rod.
